(19) United States
(12) Patent Application Publication
(10) Pub. No.: US 2008/0127223 A1
(43) Pub. Date: May 29, 2008

(54) System and method for communications operations

(76) Inventor: Christian Zechlin, Herne (DE)

Correspondence Address: MORGAN & FINNEGAN, L.L.P., 3 World Financial Center, New York, NY, 10281-2101, US

(21) Appl. No.: 11/476,540

(22) Filed: Jun. 27, 2006

(51) Int. Cl. G06F 9/44

(52) U.S. Cl. 719/321

(57) ABSTRACT

Systems and methods applicable, for instance, in communications operations. A first device might, for example, receive from a second device an inquiry response that includes information conveying when the second device will be listening. The first device might, for instance, employ the information in dispatching a page at a time that the second device is understood to be listening.

### FIELD OF INVENTION

This invention relates to systems and methods for communications operations.

### BACKGROUND INFORMATION

In recent times, there has been an increase in connection among devices (e.g., via short range networking). For example, many users have increasingly come to allow connection among devices for purposes such as, for instance, peer-to-peer operation, data access, and/or peripheral access (e.g., access to printers and/or input devices).

Accordingly, there may be interest in technologies that facilitate such use of devices.

### SUMMARY OF THE INVENTION

According to embodiments of the present invention, there are provided systems and methods applicable, for instance, in communications operations.

In various embodiments, a first device might receive from a second device an inquiry response that includes information conveying when the second device will be listening.

The first device might, in various embodiments, employ the information in dispatching a page at a time that the second device is understood to be listening.

### BRIEF DESCRIPTION OF THE DRAWINGS

FIG. 1 shows exemplary steps involved in initiator device operations according to various embodiments of the present invention.

FIG. 2 shows exemplary steps involved in target device operations according to various embodiments of the present invention.

FIG. 3 shows an exemplary computer.

FIG. 4 shows a further exemplary computer.

### DETAILED DESCRIPTION OF THE INVENTION

### General Operation

According to embodiments of the present invention, there are provided systems and methods applicable, for instance, in communications operations.

In various embodiments, a first device might receive from a second device, in response to an inquiry (e.g., a device discovery inquiry), an inquiry response that includes information (e.g., one or more time patterns) conveying when the second device will be listening (e.g., listening for pages).

The first device might, in various embodiments, employ the information in dispatching a page (e.g., a page seeking connection with the second device) at a time that the second device is understood to be listening.

Various aspects of the present invention will now be discussed in greater detail.

### Initiator Device Operations

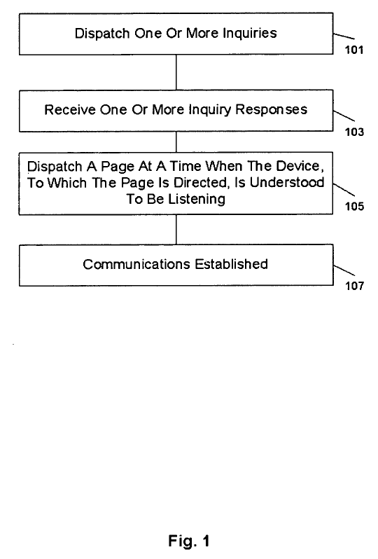

With respect to FIG. 1 it is noted that, according to various embodiments of the present invention, a device (e.g., a wireless node and/or other computer, and/or a peripheral) seeking to initiate communications might dispatch one or more inquiries (step 101).

The device might, for instance, be seeking to initiate short range networking communications. Such short range networking might, for example, involve Bluetooth and/or Wireless Fidelity (WiFi). Such Bluetooth might, for instance, correspond to IEEE 802.15.1. Such WiFi might, for instance, correspond to IEEE 802.11 (e.g., IEEE 802.11b, IEEE 802.11 g, and/or IEEE 802.11n). The inquiries might, for instance, be dispatched via such short range networking, and/or might be device discovery inquiries (e.g., a Bluetooth inquiries).

In response to the one or more inquiries the device might, for example, receive from one or more other devices (e.g., one or more other wireless nodes and/or other computers, and/or peripherals) one or more inquiry responses (step 103). Such an inquiry response might, for instance, be dispatched via short range networking of the sort discussed above (e.g., the inquiry response might be a Bluetooth inquiry response). Such an inquiry response might, for example, include information conveying when the device that dispatched the inquiry response will be listening (e.g., listening for pages).

Such information might take a number of forms. For instance, such information might be one or more time patterns and/or one or more presentations of data. Such information might, for example, specify when the device that dispatched the inquiry response will be listening. As another example, such information might, alternately or additionally, specify when the device that dispatched the inquiry will not be listening.

Such information might be provided via inquiry response in a number of ways. For instance, the information might be provided via Bluetooth Extended Inquiry Response (EIR). It is noted that, in various embodiments, the information might be provided via one or more information fields (e.g., one or more proprietary fields).

The device that has received the one or more inquiry responses might, for example, employ the received information in dispatching one or more pages to one or more devices that have provided the inquiry responses. For instance, such a page might be dispatched at a time that it was, by way of the information, understood that a device to which the page was directed would be listening (step 105). Paging might, in various embodiments, be adapted to a time pattern received via inquiry response.

The page might, for instance, be dispatched via short range networking of the sort discussed above (e.g., the page might be a Bluetooth page), and/or might be a page seeking connection. It is noted that, in various embodiments, subsequent to the sending of the page communications might be established between the device that dispatched the page and the device that received it (step 107). Such connection might, for example, be for data access, peer-to-peer operation, and/or peripheral access. Such peripheral access might, for instance, involve access to peripherals such as network access devices (e.g., cellular modems), printers, scanners, and/or human input devices (e.g., keyboards and/or mice).

It is noted that, according to various embodiments, a device so sending a page might provide a command and/or information to a networking component (e.g., an integrated and/or peripheral component). Such a networking component might, for instance, be involved in short range networking of the sort discussed above. For example, such a networking component might be a Bluetooth chip.

The command and/or information might, for example, indicate to the networking component when one or more remote devices that had dispatched inquiry responses of the sort discussed above were understood (e.g., by way of received information of the sort discussed above) to be listening. Such a command might, for instance, be a Host Controller Interface (HCI) extension command (e.g., a vendor specific extension command). Moreover, such a command and/or information might, in various embodiments, be provided to the networking component prior to (e.g., shortly before) sending to the networking component a command seeking connection with a remote device (e.g., a command that would result in a page of the sort discussed above being dispatched). For instance, such a command and/or information might be provided to the networking component prior to sending it a HCI_Create_Connection command. Interconnect to such a networking component might, in various embodiments, be provided via Inter-Integrated Circuit (I2C), Peripheral Component Interconnect (PCI), Mini Peripheral Component Interconnect (Mini PCI), Peripheral Component Interconnect Express (PCIe), Mini Peripheral Component Interconnect (Mini PCIe), Hypertransport, H4, and/or H4+.

It is noted that, in various embodiments, a device performing paging dispatch as discussed above might enjoy power savings. For example, the sending of pages to a remote device only at times that the remote device was understood to be listening might result in power savings due, for instance, to elimination and/or reduction of unnecessary page dispatch.

It is further noted that, in various embodiments, a device performing paging dispatch as discussed above might experience reduction in minimum page time. For example, minimum page time might be reduced to a default page scan window time. To illustrate by way of example, in various embodiments minimum page time for Bluetooth operation might be reduced from a time of at least 1.28 seconds to a default page scan window time of 11.25 milliseconds.

It is also noted that, in various embodiments, a device performing paging dispatch as discussed above might have communications resources (e.g., timeslots and/or bandwidth), that would have otherwise been employed for paging, available for other uses. For instance, in various embodiments the sending of pages only at times that page targets were understood to be listening might reduce and/or eliminate the sending of pages at times that targets were not listening, and communications resources so saved might be employable for other purposes.

### Target Device Operations

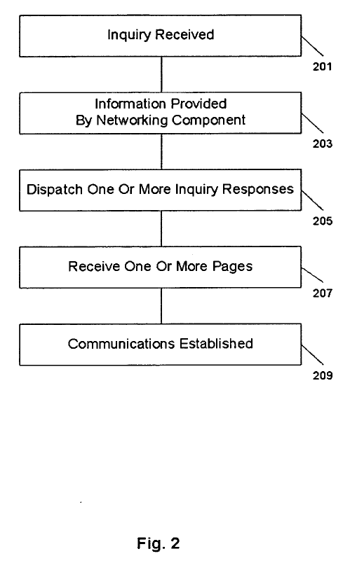

With respect to FIG. 2 it is noted that a target device (e.g., a wireless node and/or other computer, and/or a peripheral) that has received an inquiry (e.g., of the sort discussed above) (step 201) might, in various embodiments, perform one or more operations. For example, the target device might dispatch one or more inquiry responses (step 205).

Such an inquiry response might, in various embodiments, be of the sort discussed above. For instance, such an inquiry response might include information (e.g., of the sort discussed above) conveying when the target device will be listening (e.g., listening for pages). Moreover, the information might, for example, be provided via EIR as discussed above.

The target device might come to possess such information in a number of ways. For example, such information might be provided by a networking component (e.g., of the sort discussed above) (step 203). In various embodiments, the target device might provide a command to the networking component requesting such provision of information. Such a command might, for instance, be a command of the sort discussed above (e.g., an HCI extension command and/or vendor specific extension command). As another example, the target device might come to possess such information by communicating with various hardware and/or software (e.g., networking software).

Having dispatched one or more inquiry responses including such information, the target device might receive one or more pages (e.g., of the sort discussed above) from one or more devices that had received one or more of the inquiry responses (step 207). The devices dispatching the pages might, in various embodiments, do so in accordance with the information such that, for instance, the pages would be dispatched at times that the target device was understood to be listening.

Such functionality might, in various embodiments, act to reduce the time that the target device would need to listen before being paged. This reduction of time might, for instance, allow for savings of communications resources (e.g., of the sort discussed above) and/or power.

It is noted that, in various embodiments, subsequent to receipt of a page communications might be established between the device that dispatched the page and the device that received it (step 209).

### Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, telephone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

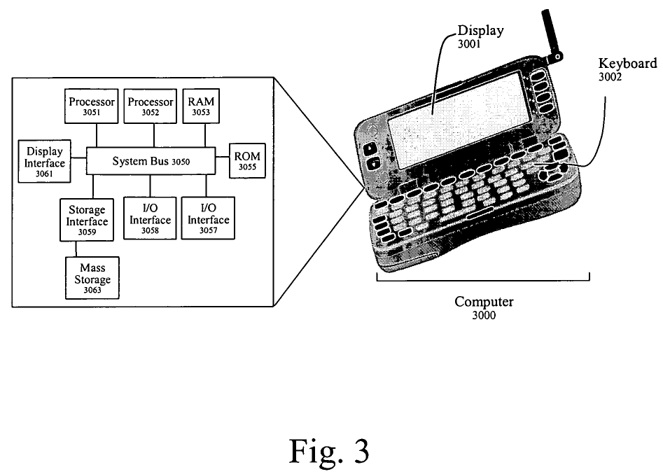

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 3 is an exemplary computer employable in various embodiments of the present invention. Exemplary computer 3000 includes system bus 3050 which operatively connects two processors 3051 and 3052, random access memory 3053, read-only memory 3055, input output (I/O) interfaces 3057 and 3058, storage interface 3059, and display interface 3061. Storage interface 3059 in turn connects to mass storage 3063. Each of I/O interfaces 3057 and 3058 may, for example, be an Ethernet, IEEE 1394, IEEE 1394b, IEEE 802.11a, IEEE 802.11b, IEEE 802.11 g, IEEE 802.11i, IEEE 802.11e, IEEE 802.11n, IEEE 802.15a, IEEE 802.16a, IEEE 802.16d, IEEE 802.16e, IEEE 802.16×, IEEE 802.20, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 3063 may be a hard drive, optical drive, a memory chip, or the like. Processors 3051 and 3052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, an Intel Core, or an IBM, Toshiba, or Sony Cell processor. Computer 3000 as shown in this example also includes a touch screen 3001 and a keyboard 3002. In various embodiments, a mouse, keypad, and/or interface might alternately or additionally be employed. Computer 3000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

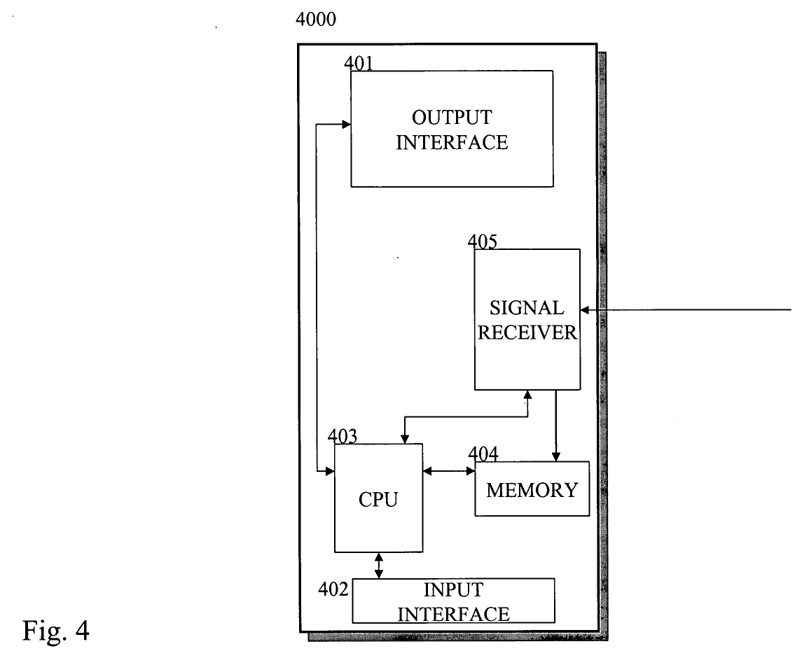

Shown in FIG. 4 is a block diagram of a terminal, an exemplary computer employable in various embodiments of the present invention. In the following, corresponding reference signs are applied to corresponding parts. Exemplary terminal 4000 of FIG. 4 comprises a processing unit CPU 403, a signal receiver 405, and a user interface (401, 402). Signal receiver 405 may, for example, be a single-carrier or multi-carrier receiver. Signal receiver 405 and the user interface (401, 402) are coupled with the processing unit CPU 403. One or more direct memory access (DMA) channels may exist between multi-carrier signal terminal part 405 and memory 404. The user interface (401, 402) comprises a display and a keyboard to enable a user to use the terminal 4000. In addition, the user interface (401, 402) comprises a microphone and a speaker for receiving and producing audio signals. The user interface (401, 402) may also comprise voice recognition (not shown).

The processing unit CPU 403 comprises a microprocessor (not shown), memory 404 and possibly software. The software can be stored in the memory 404. The microprocessor controls, on the basis of the software, the operation of the terminal 4000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the correactions of the corrupted data.

Still referring to FIG. 4, alternatively, middleware or software implementation can be applied. The terminal 4000 can, for instance, be a hand-held device which a user can comfortably carry. The terminal 4000 can, for example, be a cellular mobile phone which comprises the multi-carrier signal terminal part 405 for receiving multicast transmission streams. Therefore, the terminal 4000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

### Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
dispatching a short range networking device discovery inquiry;
receiving a short range networking inquiry response, wherein the inquiry response includes information conveying when a device dispatching the inquiry response will be listening; and
dispatching, in accordance with the information, a short range networking page seeking connection.

2. The method of claim 1, wherein the information specifies when the device dispatching the inquiry response will be listening.

3. The method of claim 1, wherein the information specifies when the device dispatching the inquiry response will not be listening.

4. The method of claim 1, further comprising providing to a short range networking component information conveying when the device dispatching the inquiry response will be listening.

5. The method of claim 1, wherein a short range networking component provides information conveying when the device dispatching the inquiry response will be listening.

6. The method of claim 1, wherein the information is provided via extended inquiry response.

7. The method of claim 1, wherein power savings are realized.

8. The method of claim 1, wherein minimum page time is reduced.

9. A method, comprising:
receiving a short range networking device discovery inquiry;
dispatching a short range networking inquiry response, wherein the inquiry response includes information conveying when listening will be performed; and
receiving a short range networking page seeking connection, wherein the page is dispatched in accordance with the information.

10. The method of claim 9, wherein the information specifies when listening will be performed.

11. The method of claim 9, the information specifies when listening will not be performed.

12. The method of claim 9, wherein a short range networking component is provided with information conveying when listening will be performed.

13. The method of claim 9, further comprising receiving from a short range networking component information conveying when listening will be performed.

14. The method of claim 9, wherein the information is provided via extended inquiry response.

15. An apparatus, comprising:
a memory having program code stored therein; and
a processor disposed in communication with the memory for carrying out instructions in accordance with the stored program code;
wherein the program code, when executed by the processor, causes the apparatus to perform:
dispatching a short range networking device discovery inquiry;
receiving a short range networking inquiry response, wherein the inquiry response includes information conveying when a device dispatching the inquiry response will be listening; and
dispatching, in accordance with the information, a short range networking page seeking connection.

16. The apparatus of claim 15, wherein the information specifies when the device dispatching the inquiry response will be listening.

17. The apparatus of claim 15, wherein the information specifies when the device dispatching the inquiry response will not be listening.

18. The apparatus of claim 15, wherein the processor further performs providing to a short range networking component information conveying when the device dispatching the inquiry response will be listening.

19. The apparatus of claim 15, wherein a short range networking component provides information conveying when the device dispatching the inquiry response will be listening.

20. The apparatus of claim 15, wherein the information is provided via extended inquiry response.

21. The apparatus of claim 15, further comprising:
a network interface disposed in communication with the processor,
wherein the apparatus is a wireless node.

22. An apparatus, comprising:
a memory having program code stored therein; and
a processor disposed in communication with the memory for carrying out instructions in accordance with the stored program code;
wherein the program code, when executed by the processor, causes the apparatus to perform:
receiving a short range networking device discovery inquiry;
dispatching a short range networking inquiry response, wherein the inquiry response includes information conveying when listening will be performed; and
receiving a short range networking page seeking connection, wherein the page is dispatched in accordance with the information.

23. The apparatus of claim 22, wherein the information specifies when listening will be performed.

24. The apparatus of claim 22, the information specifies when listening will not be performed.

25. The apparatus of claim 22, wherein a short range networking component is provided with information conveying when listening will be performed.

26. The apparatus of claim 22, wherein the processor further performs receiving from a short range networking component information conveying when listening will be performed.

27. The apparatus of claim 22, wherein the information is provided via extended inquiry response.

28. The apparatus of claim 22, further comprising:
a network interface disposed in communication with the processor,
wherein the apparatus is a wireless node.

29. An article of manufacture comprising a computer readable medium containing program code that when executed causes an apparatus to perform:
dispatching a short range networking device discovery inquiry;
receiving a short range networking inquiry response, wherein the inquiry response includes information conveying when a device dispatching the inquiry response will be listening; and
dispatching, in accordance with the information, a short range networking page seeking connection.

30. An article of manufacture comprising a computer readable medium containing program code that when executed causes an apparatus to perform:
receiving a short range networking device discovery inquiry;
dispatching a short range networking inquiry response, wherein the inquiry response includes information conveying when listening will be performed; and
receiving a short range networking page seeking connection, wherein the page is dispatched in accordance with the information.
